(19) United States
(12) Patent Application Publication
(10) Pub. No.: US 2010/0293132 A1
(43) Pub. Date: Nov. 18, 2010

(54) Methods, Systems, and Products for Detecting Maladies

(76) Inventors: Steven N. Tischer, Atlanta, GA (US); David Gibbon, Lincroft, NJ (US); N. L. Schryer, New Providence, NJ (US); Christopher Volinsky, Morristown, NJ (US)

Correspondence Address: AT&T Legal Department - SZ;Attn: Patent Docketing, Room 2A-207, One AT&T Way, Bedminster, NJ, 07921, US

(21) Appl. No.: 12/466,621

(22) Filed: May 15, 2009

(51) Int. Cl. G06N 5/02; G06N 5/04; G06K 9/00; G06F 7/00

(52) U.S. Cl. 706/54; 382/128; 707/E17.017; 707/E17.031

(57) ABSTRACT

Methods, systems, and products are disclosed for detecting and/or predicting maladies in humans and animals. Electronic copies of second order output are collected and compared to a symptoms database storing data ranges describing symptoms. When the second order output lies outside a data range, a symptom associated with the data range is retrieved. The onset of a malady associated with the symptom is then predicted.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Exemplary embodiments generally relate to data processing and, more particularly, to remote monitoring, to diagnostics, and to computer assisted medical diagnostics.

Health care can be improved. Computers are known to monitor a person's daily activities to infer the person's health. Improvements, though, would permit earlier detection of diseases and other maladies.

### SUMMARY

The exemplary embodiments provide methods, systems, and products for detecting a malady. Electronic copies of an individual's second order output are collected and compared to a symptoms database that stores data ranges describing symptoms. A symptom associated with the collected electronic copies is retrieved that lies outside a data range. A prediction is made of an onset of the malady associated with the symptom.

More exemplary embodiments include a system for detecting a malady. The system has a processor that executes code stored in memory. Recent electronic copy of an individual's handwritten signature 250 are collected and compared to historical electronic copies of the individual's handwritten signature 250s. A determination is made that the individual's handwritten signature 250 has changed over time. A symptom associated with the changed individual's handwritten signature 250 is retrieved and a prediction is made of an onset of the malady associated with the symptom.

Other exemplary embodiments describe a computer readable medium. Recent electronic copy of an individual's handwritten signature 250 are collected and compared to historical electronic copies of the individual's handwritten signature 250s. A determination is made that the individual's handwritten signature 250 has changed over time. A symptom associated with the changed individual's handwritten signature 250 is retrieved and a prediction is made of an onset of the malady associated with the symptom.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a simplified schematic illustrating an environment in which exemplary embodiments may be implemented;

FIG. 2 is a more detailed schematic illustrating the one or more databases;

FIG. 3 is another detailed schematic illustrating more of the databases;

FIG. 4 is a detailed schematic illustrating sensors, according to exemplary embodiments;

FIG. 5 is a schematic further illustrating the sensors, according to exemplary embodiments;

FIG. 6 is a schematic further illustrating the sensors, according to exemplary embodiments;

FIG. 7 is a schematic illustrating the detection of an individual's vision degradation, according to exemplary embodiments;

FIG. 8 is another schematic illustrating the individual's second order output, according to exemplary embodiments;

FIG. 9 is a block diagram of a server, according to exemplary embodiments;

FIG. 10 depicts other possible operating environments for additional aspects of the exemplary embodiments; and

FIGS. 11-13 are flowcharts illustrating a method of detecting a malady, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

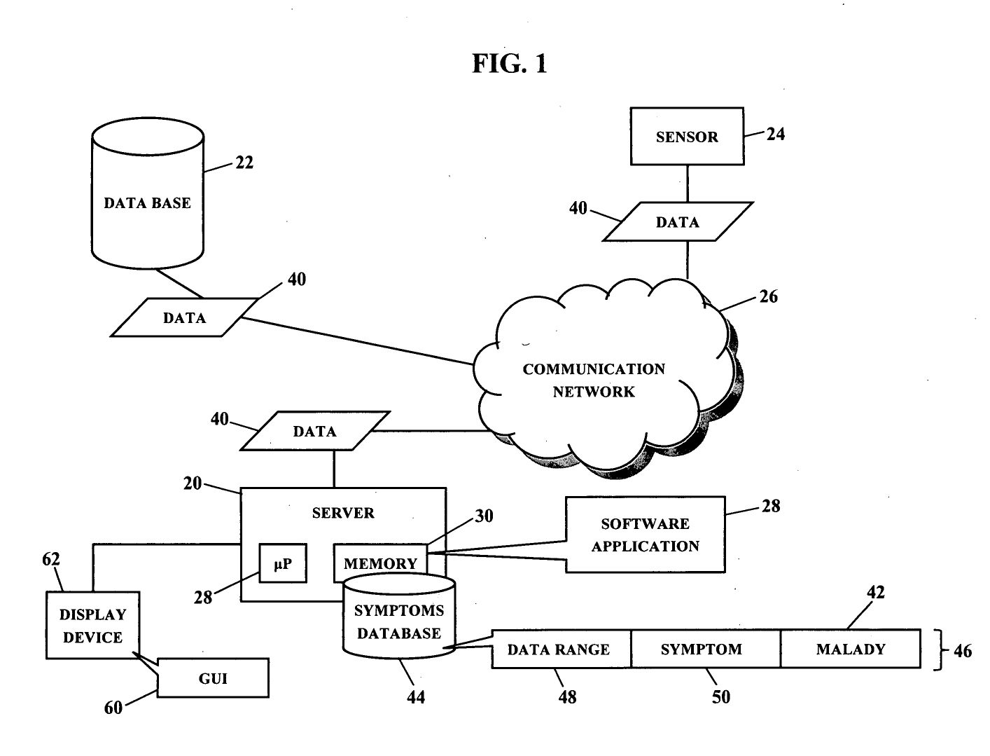

FIG. 1 is a simplified schematic illustrating an environment in which exemplary embodiments may be implemented. A server 20 communicates with one or more databases 22 and/or with one or more sensors 24 via a communications network 26. The server 20 has a processor 28 (e.g., “μP”), application specific integrated circuit (ASIC), or other device that executes a software application 28 stored in a memory 30. The software application 28 collects data 40 from the databases 22 and/or the sensors 24 and predicts when an individual or animal may suffer from a health malady 42. The software application 28 may even collect the data 40 and predict when a population or region may suffer a mass health malady, such as a flu epidemic or some other wide-spread affliction. The software application 28 includes code that causes the processor 28 to query the databases 22 and/or the sensors 24 for the data 40. The processor 28 then compares the data 40 to a symptoms database 44. The symptoms database 44 is illustrated as being locally stored in the memory 30 of the server 20, but the symptoms database 44 may be remotely accessed via the communications network 26. The symptoms database 44 is illustrated as a table 46 that maps, relates, or otherwise associates data ranges 48 with symptoms 50 and with one or more of the maladies 46. If any of the data 40 lies outside a particular data range 48, then the processor 28 retrieves the symptom 50 associated with the data range 48. The processor 28 may then predict an onset of the malady 42 associated with the symptom 50. The processor 28 may then visually produce a graphical user interface 60 on a display device 62. The graphical user interface 60 may visually display any of the data 40, the data range 48, the symptom 50, and the malady 42. The graphical user interface 60 may also have audible features.

Some aspects of health monitoring and prediction are known, so this disclosure will not greatly explain the known details. If the reader desires more details, the reader is invited to consult the following sources, with each incorporated herein by reference in their entirety: U.S. Patent Application Publication 2008/0162352 to Gizewski; U.S. Patent Application Publication 2008/0146892 to LeBoeuf, et al.; U.S. Patent Application Publication 2008/0045804 to Williams; U.S. Patent Application Publication 2007/0152837 to Bischoff, et al.; U.S. Patent Application Publication 2005/0234310 to Alwan, et al.; U.S. Pat. No. 7,396,331 to Mack, et al.; U.S. Pat. No. 7,244,231 to Dewing, et al.; U.S. Pat. No. 7,146,348 to Geib, et al.; U.S. Pat. No. 7,091,865 to Cuddihy, et al.; U.S. Pat. No. 7,001,334 to Reed, et al.; U.S. Pat. No. 6,825,761 to Christ, et al.; U.S. Pat. No. 6,816,603 to David, et al.; U.S. Pat. No. 6,611,206 to Eshelman, et al.; U.S. Pat. No. 6,238,337 to Kambhatla, et al.; U.S. Pat. No. 6,002,994 to Lane, et al.; U.S. Pat. No. 5,692,215 to Kutzik, et al.; and U.S. Pat. No. 5,410,471 to Alyfuku, et al.

The server 22 is only simply illustrated. Because the architecture and operating principles of computers and processor-controlled devices are well known, their hardware and software components are not further shown and described. If the reader desires more details, the reader is invited to consult the following sources: ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (8^{th} Ed., 2009); and DAVID A. PATTERSON & JOHN L. HENNESSY, COMPUTER ORGANIZATION AND DESIGN: THE HARDWARE/SOFTWARE INTERFACE (3^{rd}. Edition 2004).

Exemplary embodiments may be applied regardless of networking environment. The communications network 26 may be a cable network operating in the radio-frequency domain and/or the Internet Protocol (IP) domain. The communications network 26, however, may also include a distributed computing network, such as the Internet (sometimes alternatively known as the “World Wide Web”), an intranet, a local-area network (LAN), and/or a wide-area network (WAN). The communications network 26 may include coaxial cables, copper wires, fiber optic lines, and/or hybrid-coaxial lines. The communications network 26 may even include wireless portions utilizing any portion of the electromagnetic spectrum and any signaling standard (such as the I.E.E.E. 802 family of standards, GSM/CDMA/TDMA or any cellular standard, and/or the ISM band). The communications network 26 may even include powerline portions, in which signals are communicated via electrical wiring. The concepts described herein may be applied to any wireless/wireline communications network, regardless of physical componentry, physical configuration, or communications standard(s).

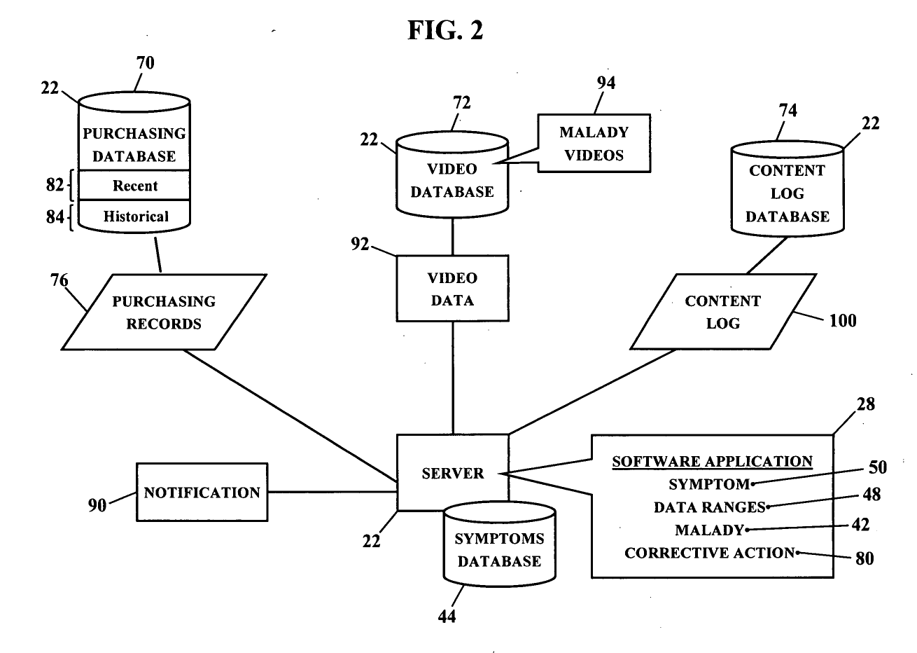

FIG. 2 is a more detailed schematic illustrating the one or more databases 22. Here the server 22 may access a purchasing database 70, a video database 72, and/or a content log database 74. The software application 28, for example, causes the processor 28 to query the purchasing database 70 for purchasing records 76. The purchasing records 76 include any data or information that describes the purchases made by an individual or by a group of people. The purchasing records 76, for example, may include credit card purchase records associated with the particular individual and/or with a group of individuals. When the individual makes purchases using a credit card, those purchases are associated with the individual. The software application 28 may then retrieve the purchasing records 76 and predict the onset of the malady 42, based on the individual's purchases.

Food purchases provides an example. When the individual makes purchases at groceries or restaurants, those purchases may be sorted and stored in the purchasing database 70. Food purchases may be sorted from non-food purchases (such as gasoline and clothing). The purchasing records 76 may describe what food was purchased, from whom the food was purchased, and the quantity. The purchasing records 76 may then be compared to the symptoms database 44. The symptoms database 44 may store the acceptable ranges 48 of particular food stuffs, perhaps according to accepted daily or weekly health advisories and/or guidelines. When the purchasing records 76 lie outside the acceptable range(s) 48, then the software application 28 may retrieve the symptom 50 associated with the acceptable range(s) 48. The software application 28 may then predict the onset of the malady 42 associated with the symptom 50. Suppose, for example, that excessive amounts of sugared soda are purchased on a daily basis. The software application 28 may retrieve the symptom 50 associated with excessive sugar consumption, such as high glucose blood levels. The software application 28 may then predict the onset of diabetes associated with the high glucose blood levels. The software application 28 may also retrieve other symptoms 50 associated with excessive sugar consumption, such as dental cavities, increasing weight, and hyperactivity. The software application 28 may even warn of other possible afflictions, such as methamphetamine addiction. The software application 28 may also monitor the purchases of alcoholic beverages and predict when alcoholic consumption may lead to liver failure, emotional problems, weight gain, and addiction. The software application 28 may also predict emotional issues that accompany the malady 42, such as violent and/or criminal tendencies or social withdrawal.

The software application 28 may also make recommendations. When the software application 28 predicts the onset of the malady 42 associated with the symptom 50, the software application 28 may also recommend corrective action 80. When the individual purchases excessive sugared drinks, for example, the software application 28 may recommend alternative purchases, such as water, milk, or other non-sugared liquids. The software application 28 may even be configured to suspend or deny future purchases that do not conform to the accepted ranges. The software application 28, for example, may cause future or subsequent purchases of sugared drinks to be denied by a credit card issuer, thus preventing the individual from purchasing additional sugared drinks. The software application 28 may further cause future/subsequent purchases of any food stuff to be denied to ensure the accepted ranges 48 are achieved.

The software application 28 may also monitor and track long term food purchases. The purchasing database 70 may be physically or logically divided into recent 82 and historical purchasing 84 databases. The software application 28 may compare recent purchase records to historical purchase records and determine changes over time. The historical purchase records may be tracked and monitored by linear analysis, by computing an average purchase quantity for a commodity, or by using any other measurement method. Any changes over time may be compared to the ranges 48. If a change lies outside the acceptable range 48, then the software application 28 retrieve the symptom 50 associated with the range 48 and predicts the onset of the associated malady 42.

The software application 28 may also notify of the symptom 50 associated with the malady 42. When the software application 28 detects that the individual's (or group's) purchasing records 76 lie outside the data range 48, the software application 28 may cause the processor to send a notification 90 to a destination address (via the communications network 26 illustrated in FIG. 1). The notification 90 may be any electronic, text, analog, or audible message that alerts of the purchasing records 76, the data range 48, the symptom 50, and/or the malady 42. The notification 90 may be a text message, email, call, or any other digital or analog communication. The notification 90 may be sent to any communications address associated with the individual and/or group to warn of the malady 42. The notification 90 may also be sent to retailers, service providers, or other businesses to alert of the malady 42. The notification 90 may also be sent to law enforcement, health agencies, and/or emergency providers to alert of the malady 42. If the software application 28 predicts excessive sugar consumption is associated with methamphetamine usage, then the notification 90 may be sent to police, ambulance, and health authorities. If the software application 28 is configured to suspend or deny future purchases that do not conform to the accepted ranges 48, the software application 28 may send the notification 90 to a credit card issuer. The credit card issuer may then deny subsequent purchases of offending products, thus preventing the individual from making additional offending purchases.

The video database 72 may also be queried for video data 92. The video data 92 includes any analog or digital video data obtained from any public or private source. As “web cams,” video surveillance, and digital cameras become more and more ubiquitous, the video database 72 may store videos of our public and private doings. A routine trip to the mall, for example, may be captured by cameras at a town traffic intersection, by a surveillance camera in a mall parking lot, and by surveillance cameras within the stores in the mall. The video data 40 may also be captured from cell phones, computers, home web cams, doctor offices, public spaces, and any other public and private sources. Although FIG. 2 only illustrates a single video database 72, the software application 28 may access many different databases (via the communications network 26) to obtain the video data 92. The software application 28 analyzes any and/or all of this video data 92 to predict the onset of the malady 42. Exemplary embodiments thus use rich media to predict internal maladies from external evidence.

The video data 92 may identify health changes over time. Recent video data 92 may be compared to historical video data 92 to detect physical and emotional changes over time. Long term analysis of the video data 92 may reveal, for example, muscular tremors that indicate the onset of Parkinson's disease. Long term analysis of the video data 92 may also reveal changes in an individual's gait or walk, perhaps predicting the onset of hip ailments, multiple sclerosis, muscular dystrophy, and other maladies. The software application 28 compares the video data 92 to the ranges 48. If aspects within the video data 92 lie outside the acceptable range 48, then the software application 28 retrieves the symptom 50 associated with the range 48 and predicts the onset of the associated malady 42.

The video database 72 may also be queried for exemplary malady videos 94. Each exemplary malady video 94 is a sample video of a more advanced stage of each malady 42. When the software application 28 predicts the malady 42, the software application 28 may then query the video database 72 for the corresponding exemplary malady video 94. Continuing with the above example, suppose the software application 28 predicts the onset of diabetes associated with high glucose blood levels. The software application 28 may then retrieve the corresponding exemplary malady video 94 that is associated with diabetes. The software application 28 may then cause the processor to present, generate, or display the exemplary malady video 94 (perhaps within the graphical user interface 60 illustrated in FIG. 1) of advanced stages of diabetic patients. When additional symptoms are associated with excessive sugar consumption, such as dental cavities, increasing weight, and hyperactivity, then the software application 28 may cause display of other videos warning of these long term complications or afflictions. Videos of methamphetamine addiction may even be shown, along with videos describing violent and/or criminal tendencies or social withdrawal. The purpose of each exemplary malady video 94 is to urge the individual to recognize early-onset symptoms, to seek early intervention medical help, and to avoid the more serious long term symptoms.

The content log database 74 may also be queried for a content log 100. The content log 100 includes a listing or log of content searches and web pages associated with the individual (or group). Whenever the individual uses a content search engine (such as GOOGLE®, YAHOO®, or YOU TUBE®) to conduct a content search, that content search is recorded, or logged, in the content log 100 associated with the individual. Whenever the individual downloads web pages, movies, files, or any other content, a topical description and title of the content may be stored in the content log 100 associated with the individual. The software application 28 queries the content log database 74 for the content log 100. The software application 28 then uses content log 100 to predict the onset of the malady 42.

Exemplary embodiments thus use content searches and content selections to predict maladies. When the software application 28 retrieves the purchasing records 76 from the purchasing database 70, the content log 100 may be correlated to the individual's purchasing records 76. When the individual's content searches and content selections correlate to the individual's purchasing records 76, that correlation may cause the software application 28 to retrieve the symptom 50 associated with the malady 42. Suppose, for example, that the content log 100 indicates the individual requested a search at www.webmd.com or some other health-oriented website. The content log 100 also indicates that the topical description of the search was “hyperglycemia” and title of the downloaded content was “The Signs & Symptoms of Diabetes.” Suppose also that the individual's purchasing records 76 indicate a reduction in the purchase of sugared drinks, and an increase in the purchase of fibered foods, when compared to historical ranges 48. The software application 28 may infer, from the content log 100, that the individual is concerned about hyperglycemia and diabetes. The software application 28 may retrieve the symptoms 50 associated with hyperglycemia and diabetes and predict, based on the changes in the individual's purchasing records 76, the onset of diabetes. Exemplary embodiments may predict the onset of influenza, a common cold, or any other illness that can be correlated to content searches and to purchases.

The content log 100 may also be used to predict emotional health. Because content log 100 tracks content searches and downloads, the individual's content selections may be used to infer the individual's emotional and mental health. Health professionals develop ranges and other indicators of activities or traits that may indicate mental and/or emotional issues. These ranges and indicators are then compared to the individual's content log 100. When the individual frequently searches and/or downloads weapons-making information, the software application 28 may retrieve symptoms 50 associated with antisocial behavior, revolutionary activity, and violent tendencies. Whatever the individual's content log 100 indicates, the software application 28 retrieves the associated symptoms 50 and predicts the corresponding maladies xx.

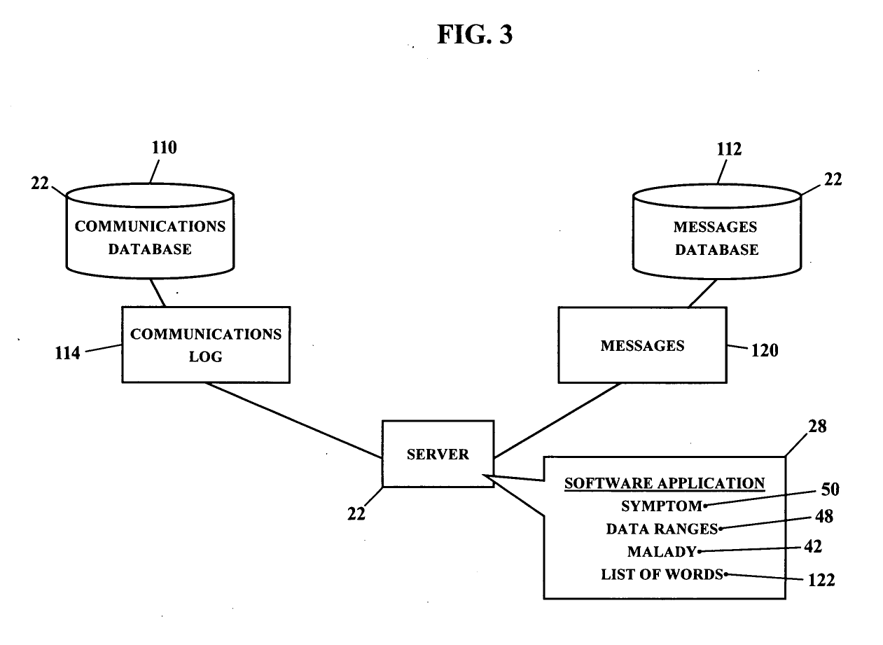

FIG. 3 is another detailed schematic illustrating more of the databases 22. Here the server 22 may access a communications database 110 and a messages database 112 when predicting the malady 42. The software application 28, for example, causes the processor 28 to query the communications database 110 for a communications log 114 associated with the individual (or group). Whenever the user sends or receives a communication, of any type, that communication is logged in the individual's communications log 114. If the individual makes or receives a telephone call or Voice over Internet Protocol call, the date and time is recorded in the individual's communications log 114. The calling number or address and the called number or address is also recorded in the individual's communications log 114. Electronic communications, including emails, voicemails, instant messages, web postings, and facsimile messages, are similarly recorded in the individual's communications log 114. The date and time of receipt or send, along with the originating and destination address, is recorded in the individual's communications log 114. Any and all analog or digital communications associated with the individual, or with any communications device associated with the individual, is logged in the individual's communications log 114.

The software application 28 then uses the communications log 114 to predict the onset of the malady 42. The software application 28 compares the individual's recent communications with the individual's historical communications. Deviations from established norms or habits may indicate the symptoms 50 associated with the malady 42. As the individual's communications log 114 grows over time, patterns may develop. Historical patterns may reveal frequent or habitual calls to/from a number or communications address. The historical patterns may also reveal frequent or periodic messages to/from a communications address, such as a friend's or relative's cell phone or email. Postings on social networks or other websites may also be logged and monitored. When the software application 28 retrieves the individual's communications log 114, the software application 28 may analyze the communications log 114 to determine the individual's social relationships. The software application 28 compares the communications log 114 to the ranges 48. Here, though, the ranges 48 represent historical norms or patterns developed over time that describe the individual's social relationships. Changes or deviations from the ranges 48 may be associated to the symptom 50 and to the malady 42. If the frequency of the individual's communications decreases, for example, that decrease may indicate a tendency toward social seclusion, mental degradation, Alzheimer's disease, and/or alcoholism. If the individual's communications log 114 indicates a decreasing use of telephony, and an increasing use of text-based messaging, the software application 28 may infer a change in hearing ability. An increasing use of audible or voice communications, similarly, may indicate symptoms of vision degradation due to retina failure, glaucoma, or other vision maladies. If communications to a particular communicating partner (or communications address) significantly reduce, or abruptly cease, that reduction may indicate a breakdown in the relationship, a grieving loss due to death, or perhaps a physical injury or incapacitation. The communications log 114 allows the software application to observe and/or to predict changes in the individual's mental, emotional, or physical health.

The software application 28 may also query the messages database 112 for messages 120. The messages database 112 stores electronic copies of messages sent and received by the individual (or group). Some or all of the user's text messages, for example, are forwarded and/or stored in the messages database 112. Voicemails and other audible messages may also be stored in the messages database 112. The software application 28 accesses a list 122 of words or phrases stored in the memory 30. The software application 28 then queries the messages database 112 for any of the individual's messages that contain any of the words or phrases in the list 122. Here, though, the words or phrases relate to mental, emotional, and physical health. If any of the individual's messages contains the words or phrases, the corresponding message 120 is returned to the software application 28. The software application 28 then compares the text within the message 120 to the ranges 48. The ranges 48 correspond to mental, emotional, and physical health. The software application 28 then retrieves the associated symptoms 50 and predicts the corresponding maladies 42 that are associated with the words or phrases in the list 122.

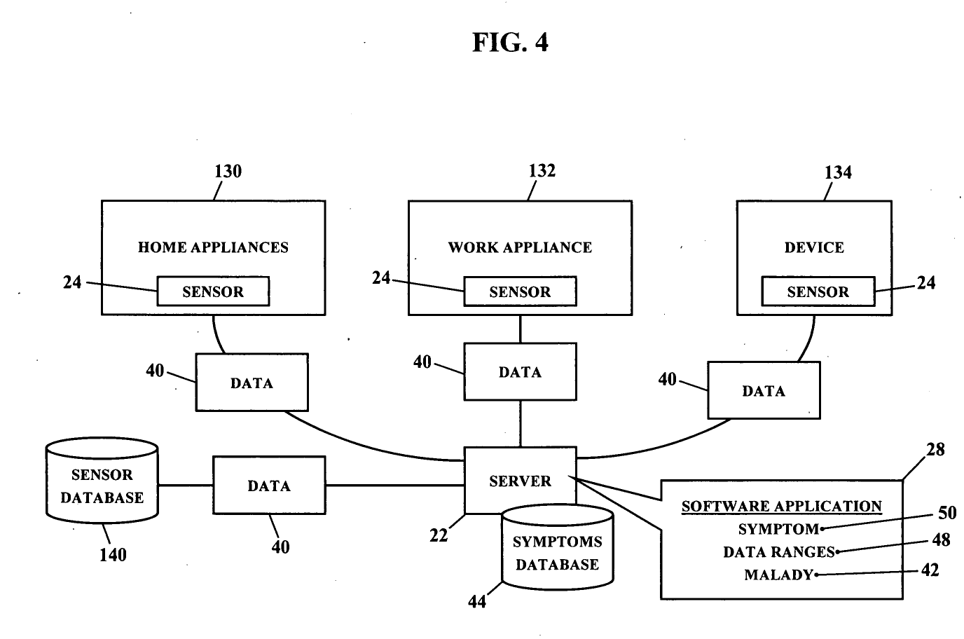

FIG. 4 is a detailed schematic illustrating the sensors 24 (illustrated in FIG. 1), according to exemplary embodiments. FIG. 4 illustrates home appliances 130, work appliances 132, and devices 134 that include the sensors 24. As the individual or group interacts, handles, interfaces, or uses any of the applications 130 and 132 or devices 134, the sensors 24 collect any information that can be used to infer the health of the individual. The sensors 24, for example, may collect information related to blood pressure 210, heart rate, body weight, temperature 212, sweat level, chemical composition, or physical appearance. The sensors 24 collect the data 40 and store the data 40 in a sensor database 140. The sensor database 140 is illustrated as being remotely located from the server 20, but the sensor database 140 may be locally stored in the server 22. The software application 28 may then query the sensor database 140 to retrieve the data 40. The software application 28 then compares the data 40 to the ranges 48 in the symptoms database 44. If any of the data 40 lies outside a particular data range 48, then the software application 28 retrieves the symptom 50 associated with the data range 48 and predicts the onset of the associated malady 42.

The sensors 24 may detect, measure, and/or read any physical quantity. The sensors 24, for example, may measure current, voltage, resistance, light, color, turbidity, force, pressure 210, scent/pheromones, chemical composition, and changes in chemical composition. The sensors 24 may even capture or measure visible characteristics, such as blood vessel patterns in retinas and in hands. The sensors 24 may be incorporated into home appliances (refrigerators, ovens, blenders, hair dryers, washers, dryers). The sensors 24 may be incorporated into computers, copiers, printers, phones, pagers, and other devices.

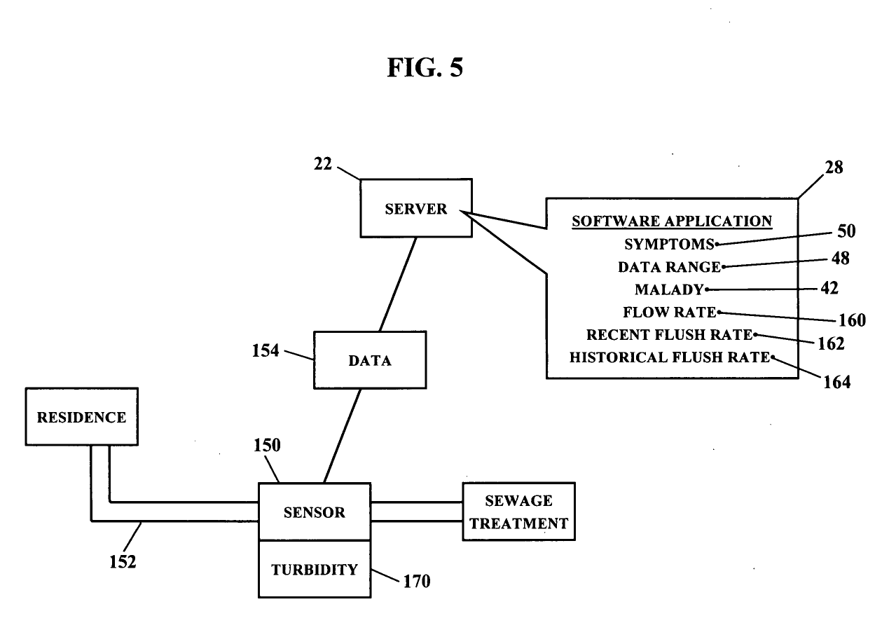

FIG. 5 is a schematic further illustrating the sensors 24, according to exemplary embodiments. Here a sewage sensor 150 is installed in a residential sewage drain 152. The sewage sensor 150 analyses the sewage that flows through the residential sewage drain 152. The sewage sensor 150 sends sewage data 154 to the server 22. The software application 28 may then compare the sewage data 154 to the ranges 48 to predict the onset of the malady 42 (as explained above). The sewage sensor 150, for example, may measure chemical composition of the sewage that flows through the sewage drain 152. The sewage sensor 150, though, may additionally or alternatively measure a flow rate 160 through the sewage drain 152, such as gallons/liters per unit of time (second, minute, hour). The software application 28 may then convert the flow rate 160 to a number 162 of toilet flushes per unit of time. Newer “low consumption” toilets may consume one (1) gallon per flush, while older toilets may consume five (5) gallons or more per flush. The software application 28 may store the average number of gallons per flush, the software application 28 may convert the flow rate 160 to the number 162 of toilet flushes per unit of time (or “toilet flush rate” 162):

$$\frac{gallons}{minute} \times \frac{flush}{gallons} = \frac{flushes}{minute} .$$

The toilet flush rate 162 may then be used to infer the health of the individual, or individuals, in the residence. The software application 28 may continuously or periodically track, monitor, and store the recent number 162 of flushes per minute and a historical range 48 of flushes per minute, perhaps according to a±1σ, ±2σ, or ±3σ Gaussian distribution. The software application 28, for example, may compare the recent number 162 of flushes per minute to a historical flush rate 164. Whenever the recent number 162 of flushes per minute lies outside the historical range 48 of flushes per minute, and/or exceeds the historical flush rate 164, then the software application 28 may infer that some health concern (e.g., influenza, stomach virus, or diarrhea) exists within the residence. The software application 28 may then retrieve the symptom 50 and predict the onset of the associated malady 42.

Many factors, of course, may influence the flow rate 160 through the sewage drain 152. The discharge flow from extra washing machine cycles and visiting guests' showers, for example, may temporarily increase the flow rate 160. The sewage sensor 150 may thus include a turbidity sensor 170 (turbidimeter) to help distinguish body waste. The software application 28 may discount or ignore recent increases in the flow rate 160 when particulate matter readings are within an acceptable range 48 of particulates. Conversely, when particulate matter readings lie outside the acceptable range 48 of particulates, the software application 28 may then retrieve the symptom 50 and predict the associated malady 42. The software application 28 may also produce a prompt in the graphical user interface (illustrated as reference numeral 60 in FIG. 1) that alerts of the increased flow rate 160. If non-health related issues are causing the increased flow rate 160, the individual user may instruct the software application 28 to ignore the increased flow rate 160.

The sewage sensor 150 may alternatively or additionally collect the sewage data 40 from downstream regional locations. The sewage sensor 150 may be placed to collect the sewage data 40 from a regional junction of multiple residences. The software application 28 may still analyze sewage, but the regional location of the sewage sensor 150 may permit only regional health inferences for multiple residences. Still, though, exemplary embodiments may estimate regional symptoms and maladies when the ranges 48 reflect regional values.

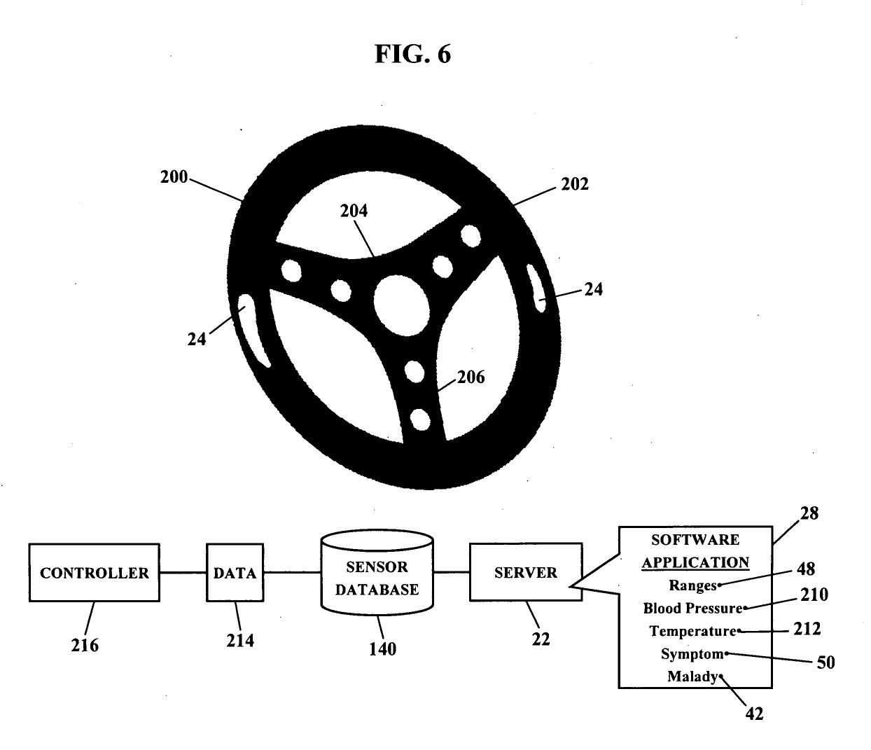

FIG. 6 is a schematic further illustrating the sensors 24, according to exemplary embodiments. Here the sensors 24 may measure the individual's blood pressure and temperature. The sensors 24 are illustrated as being incorporated into a vehicular steering wheel 200, but the sensors 24 could be incorporated into a yoke, joystick, or other controller. The steering wheel 200 has an outer rim 202, and inner hub 204, and one or more spokes 206 connecting the inner hub 204 to the outer rim 202. The outer rim 202 includes the one or more sensors 24 that detect the individual driver's blood pressure 210 and temperature 212. The sensors 24 are preferably placed or located along an outer edge of the outer rim 202 if blood pressure 210 and/or temperature 212 is to measured from the individual driver's palm. The sensors 24 may optionally be integrated along an inner edge of the outer rim 202 if blood pressure 210 and/or temperature 212 is to measured from the individual driver's finger tips. The sensors 24 may also be placed or located at a ten o'clock position and/or a two o'clock position on the outer rim 202. These rim locations would correspond to left and right hand positions on the steering wheel 200.

The sensors 24 measure information related to the individual driver's blood pressure 210 and temperature 212. The sensors 24 send pressure and/or temperature data 214 to a vehicular controller 216. The vehicular controller 216 comprises a processor, memory, and communications interface (not shown for simplicity). The processor causes the communications interface to wirelessly send, transmit, or communicate the pressure and/or temperature data 214 to the sensor database 140. The software application 28 may then retrieve the pressure and/or temperature data 214 and compare to the ranges 48. Here the ranges 48 are configured to reflect acceptable ranges of blood pressure 210 and temperature 212 readings or values. If the pressure 210 and/or temperature 212 data 40 lie outside the ranges 48, software application 28 retrieves the associated symptom 50 and predicts the associated malady 42 (as explained above).

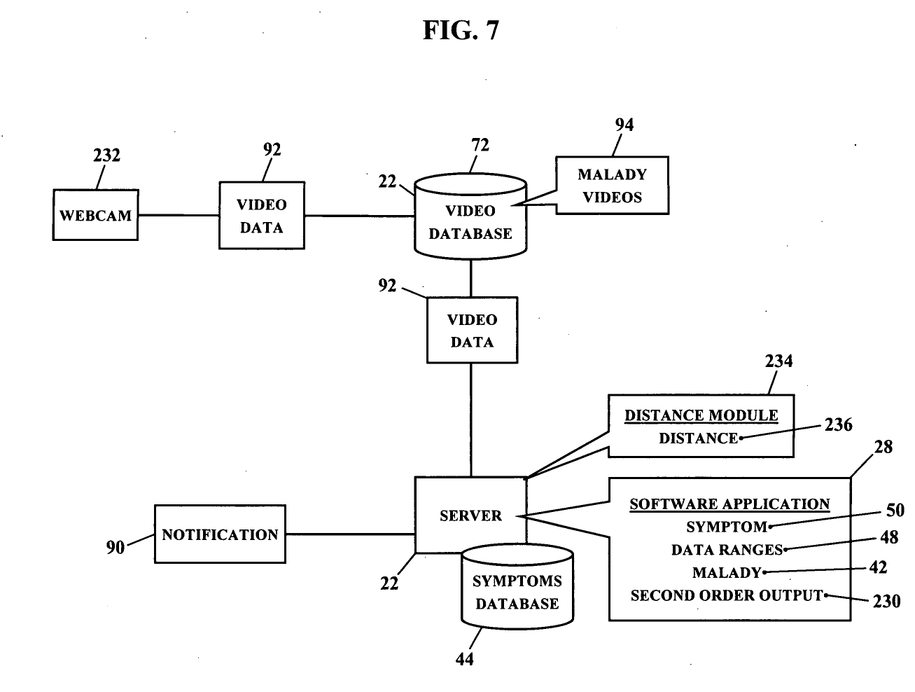

FIG. 7 is a schematic illustrating the detection of an individual's vision degradation, according to exemplary embodiments. Here the software application 28 uses an individual's second order output 230 to predict degradation in the individual's vision. The term “second order outputs” are those human outputs that require expansive, higher order intelligence and an understanding of causal relationships. Second order outputs are distinguished from “first order outputs,” such as defecation, urination, sneezing, and other natural, low intelligence functions. As the following paragraphs will explain, exemplary embodiments use an individual's second order output 230 to predict degradation in the individual's vision. Exemplary embodiments, in particular, detect changes in an individual's depth/distance perception to infer vision degradation.

FIG. 7 illustrates a webcam 232 that captures the video data 40. Here the webcam 232 is trained or aligned to monitor a parking lot or parking space in a public or private location. The webcam 232 captures the individual parking a vehicle in a parking space. The webcam 232 captures the video data 40 and sends the video data 40 to the video database 72. The software application 28 queries for and retrieves the video data 40. The software application 28 calls or invokes a distance module 234. The distance module 234 is a software tool or routine that computes or estimates distances between objects in the video data 40. Here the software application 28 calls the distance module 234 to determine a distance 236 between adjacent vehicles in the video data 40. The distance module 234 determines the distance 236 and also determines or retrieves a historical range 48 of distances. The historical range 48 of distances is the range of historical distances between adjacent vehicles for the same individual. The historical range 48 of distances is determined from a long term accumulation and analysis of the video data 40 over years of the individual's parking maneuvers stored in the video database 72. When the distance 236 during the individual's recent parking maneuver lies outside the historical range 48 of distances, then the software application 28 queries the symptoms database 44 and retrieves the symptom 50 associated with the historical range 48 of distances. In this example the symptom 50 is a degradation in the individual's estimation of the distance 236, which is the second order output 230. Other vision-related symptoms 50 may include nighttime “blurs” or “starbursts” when viewing lights, near- or far-sightedness, or changing peripheral vision. Because the individual's second order output 230 is changing, exemplary embodiments may then use the symptom(s) 50 to predict the onset of cataracts, diabetes, cancer (smoking), and other associated maladies 42.

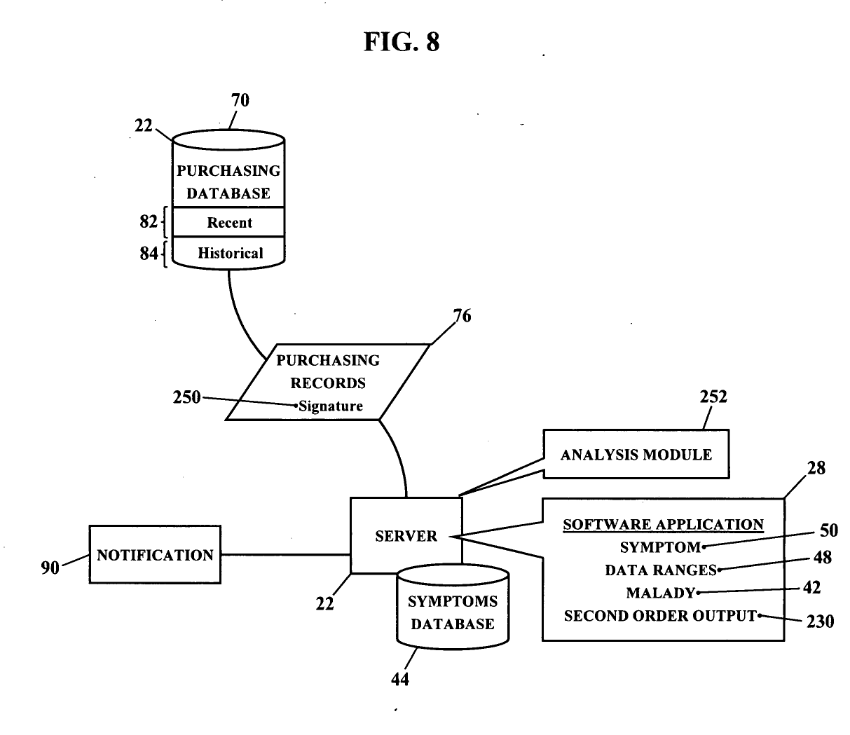

FIG. 8 is another schematic illustrating the individual's second order output 230, according to exemplary embodiments. Here the software application 28 uses the individual's handwritten signature 250 to predict vision degradation, Parkinson's, and other maladies 42. The software application 28 queries the purchasing database 70 for the purchasing records 76. The purchasing records 76 include electronic copies of the individual's handwritten signatures 250 associated with, for example, credit card purchases. When the individual makes purchases using a credit card, an electronic copy of the individual's handwritten signature 250 is also stored in the purchasing database 70. Over time the purchasing database 70 may store months or even years of samples of the individual's handwritten signature 250. The software application 28 may call or invoke a software analysis module 252 that compares the electronic copies of individual's handwritten signatures 250. The analysis module 252 determines the historical range 48 of characteristics that describes or characterizes the individual's handwritten signature 250 accumulated over months or years of analysis. When recent electronic copies lies outside the historical range 48 of characteristics, then the software application 28 queries the symptoms database 44 and retrieves the symptom(s) 50 associated with the historical range 48 of characteristics. In this example the symptom 50 may be degradation in the individual's vision, muscular degradation, joint pain, and/or others. Because the individual's second order output 230 is changing, exemplary embodiments may then use the symptom(s) 50 to predict the onset of cataracts, arthritis, Parkinson's, radial blockage, and other associated maladies 42.

Exemplary embodiments may be offered as a subscription service. Some people may find the daily accumulation and analysis of the video data 40, the purchasing records 76, and the other data 40 too intrusive and even offending. Other people, though, may welcome the accumulation and analysis of the data 40 to help them detect the onset of the malady 42 and obtain early intervention. For those people who desire such accumulation and analysis, a service provider may offer a subscription service. When a customer subscribes to this service, any publically-available data is accumulated and analyzed, as discussed above. Even private data, if obtainable, may also be accumulated and analyzed. The subscription service may even provide options for the subscriber to “opt in” or “opt out” of particular data, sources of data, and/or data collection techniques. The subscription service may even provide an “always on” option that collects/records data from any and all available sources, whether public (restaurant cams, traffic cams, and other public-spaces cameras) or private (in-home cams, co-worker cams, set top box cam). However the data is collected, the data may be tagged, associated with, and/or correlated to the subscriber's name or account number.

The software application 28 may be written or developed as layers. A public layer, for example, collects/records publically available data. Public data is knowingly shared to benefit the public and to promote social health. The software application 28, however, may also include a private layer in which data is only shared with authorized and/or identified parties (such as physicians and family members). The software application 28 may even include an anonymity feature that shares private data with the public, but personally identifying information is deleted or parsed.

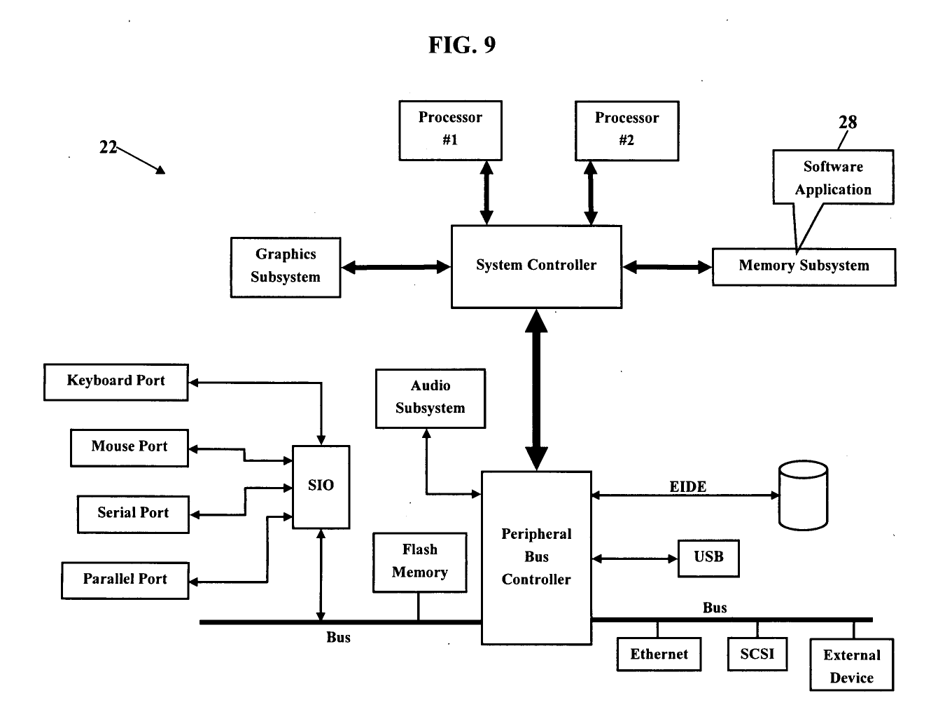

FIG. 9 is a block diagram of the server 22, according to exemplary embodiments. FIG. 9 is a generic block diagram illustrating the software application 28 operating within the server 22. The software application 28 may be stored in a memory subsystem of the server 22. One or more processors communicate with the memory subsystem and execute the software application 28. Because the server 22 illustrated in FIG. 9 is well-known to those of ordinary skill in the art, no detailed explanation is needed.

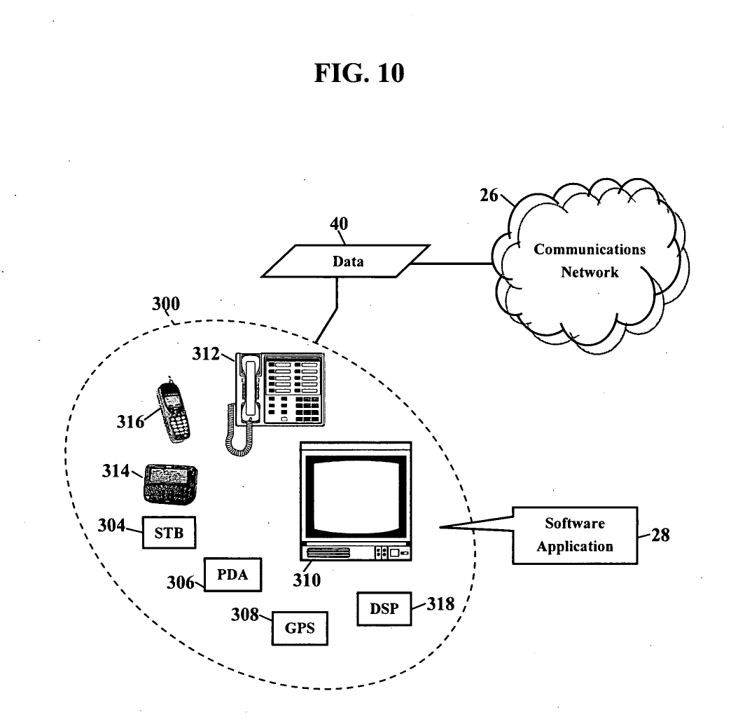

FIG. 10 depicts other possible operating environments for additional aspects of the exemplary embodiments. FIG. 10 illustrates that the software application 28 may alternatively or additionally operate within other processor-controlled devices 300. FIG. 10, for example, illustrates that the software application 28 may entirely or partially operate within a set top box 304, personal digital assistant (PDA) 306, a Global Positioning System (GPS) device 308, television 310, an Internet Protocol (IP) phone 312, a pager 314, a cellular/satellite phone 316, or any system and/or communications device utilizing a digital processor and/or a digital signal processor (DP/DSP) 318. The device 300 may also include watches, radios, vehicle electronics, clocks, printers, gateways, mobile/implantable medical devices, and other apparatuses and systems. Because the architecture and operating principles of the various devices 300 are well known, the hardware and software componentry of the various devices 300 are not further shown and described. If, however, the reader desires more details, the reader is invited to consult the following sources: LAWRENCE HARTE et al., GSM SUPERPHONES (1999); SIEGMUND REDL et al., GSM AND PERSONAL COMMUNICATIONS HANDBOOK (1998); and JOACHIM TISAL, GSM CELLULAR RADIO TELEPHONY (1997); the GSM Standard 2.17, formally known Subscriber Identity Modules, Functional Characteristics (GSM 02.17 V3.2.0 (1995-01))”; the GSM Standard 11.11, formally known as Specification of the Subscriber Identity Module—Mobile Equipment (Subscriber Identity Module—ME) interface (GSM 11.11 V5.3.0 (1996-07))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004).

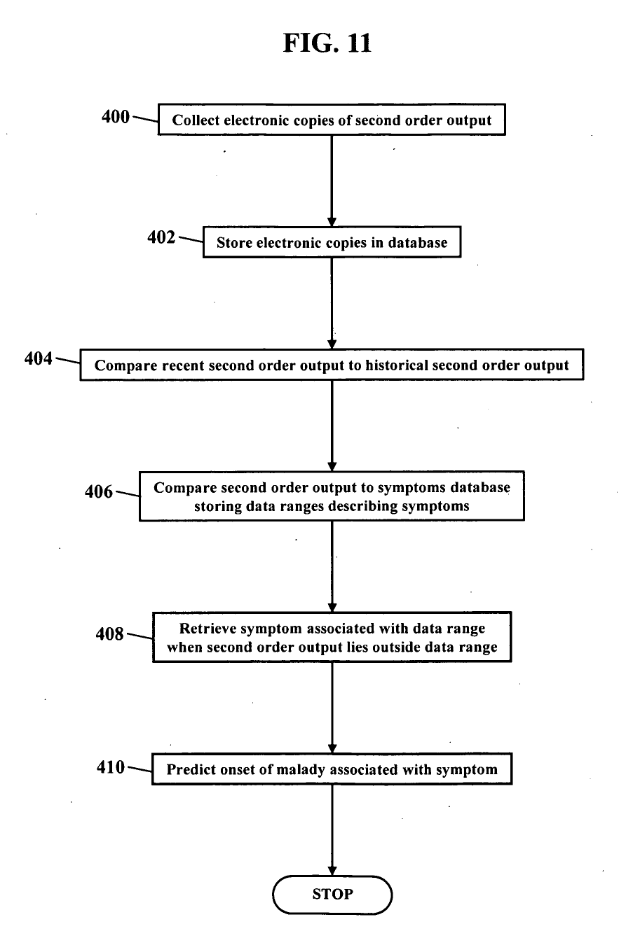

FIG. 11 is a flowchart illustrating a method of detecting a malady, according to exemplary embodiments. Electronic copies of an individual's second order output are collected (Block 400). The electronic copies are stored in a database (Block 402). Recent electronic copies of the individual's second order output are compared to electronic copies of the individual's historical second order output (Block 404). The electronic copies of the individual's second order output are compared to a symptoms database storing data ranges describing symptoms (Block 406). A symptom associated with the collected electronic copies is retrieved that lies outside a data range (Block 408). A prediction is made of an onset of the malady associated with the symptom (Block 410).

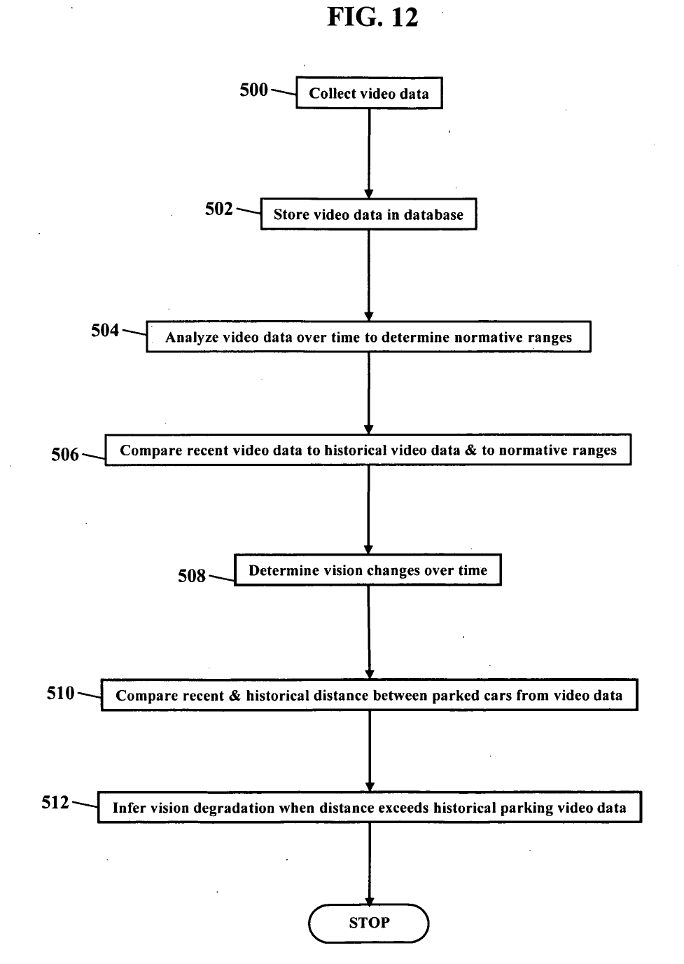

FIG. 12 is another flowchart illustrating a method of detecting a malady, according to exemplary embodiments. Video data is collected (Block 500) and stored in a database (Block 502). The video data is analyzed over time to determine normative ranges (Block 504). Recent video data is compared to historical video data and to the normative ranges (Block 506). Vision changes over time are determined (Block 508). A recent distance between parked cars and historical distances between parked cars are compared from the video data (Block 510). Vision degradation is inferred when the distance exceeds historical parking video data (Block 512).

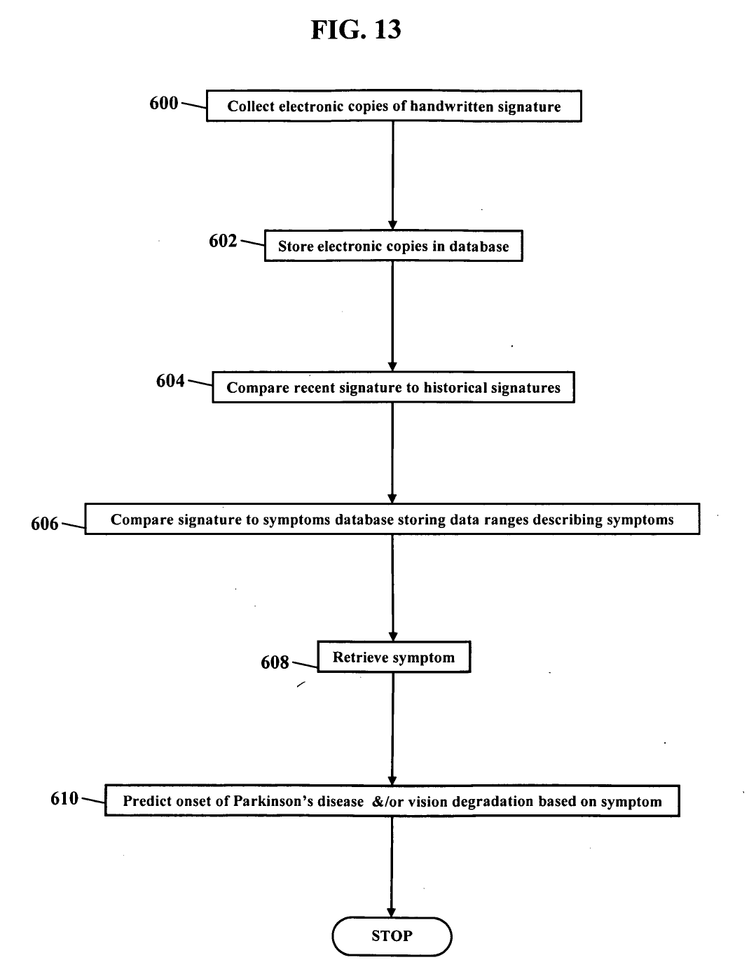

FIG. 13 is another flowchart illustrating a method of detecting a malady, according to exemplary embodiments. Electronic copies of an individual's handwritten signature 250 are collected (Block 600). The electronic copies are stored in a database (Block 602). Recent electronic copies of the individual's handwritten signature 250 are compared to historical electronic copies of the individual's handwritten signature 250 (Block 604). The electronic copies of the individual's handwritten signature 250 are compared to a symptoms database storing data ranges describing symptoms (Block 606). A symptom associated with the collected electronic copies is retrieved that lies outside a data range (Block 608). A prediction is made of an onset of Parkinson's disease and/or vision degradation is made based on the symptom (Block 610).

Exemplary embodiments may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-subscribers, licensees, and assignees. These types of computer-readable media, and other types not mention here but considered within the scope of the exemplary embodiments, permit mass dissemination of the exemplary embodiments. A computer program product comprises the computer readable medium with processor-executable instructions stored thereon.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method of detecting a malady, comprising:
collecting electronic copies of an individual's second order output;
comparing the collected electronic copies to a symptoms database storing data ranges describing symptoms;
retrieving a symptom associated with the collected electronic copies that lies outside a data range; and
predicting an onset of the malady associated with the symptom.

2. The method according to claim 1, further comprising storing the collected electronic copies in an historical database.

3. The method according to claim 2, further comprising comparing a recent second order output to a historical second order output.

4. The method according to claim 2, further comprising comparing publically available video data to historical video data to determine vision changes over time.

5. The method according to claim 2, further comprising determining a distance between parked cars in video data.

6. The method according to claim 5, further comprising comparing the distance to historical parking video data stored in the historical database.

7. The method according to claim 6, further comprising inferring vision degradation when the distance exceeds historical parking video data.

8. The method according to claim 2, further comprising storing a recent electronic copy of the individual's handwritten signature in the historical database.

9. The method according to claim 8, further comprising comparing the recent electronic copy of the individual's handwritten signature to a historical electronic copy of the individual's handwritten signature.

10. The method according to claim 9, further comprising predicting the onset of Parkinson's disease based on the comparison.

11. The method according to claim 9, further comprising predicting vision degradation based on the comparison.

12. A system for detecting a malady, comprising:
a processor executing code stored in memory that causes the processor to:
collect a recent electronic copy of an individual's handwritten signature;
compare the recent electronic copy of the individual's handwritten signature to historical electronic copies of the individual's handwritten signatures;
determine the individual's handwritten signature has changed over time;
retrieve a symptom associated with the changed individual's handwritten signature; and
predict an onset of the malady associated with the symptom.

13. The system according to claim 12, wherein the code further causes the processor to retrieve the recent electronic copy of the individual's handwritten signature from a credit card transaction.

14. The system according to claim 12, wherein the code further causes the processor to determine a change exists between the recent electronic copy of the individual's handwritten signature and the historical electronic copies of the individual's handwritten signatures.

15. The system according to claim 14, wherein the code further causes the processor to compare the change to a symptoms database storing data ranges describing symptoms.

16. The system according to claim 15, wherein the code further causes the processor to determine the change lies outside a data range.

17. The system according to claim 16, wherein the code further causes the processor to retrieve the symptom associated with the data range.

18. The system according to claim 17, wherein the code further causes the processor to predict the onset of Parkinson's disease based on the symptom.

19. The system according to claim 17, wherein the code further causes the processor to predict vision degradation based on the symptom.

20. A computer readable medium storing processor executable instructions for performing a method, the method comprising:
collect a recent electronic copy of an individual's handwritten signature;
compare the recent electronic copy of the individual's handwritten signature to historical electronic copies of the individual's handwritten signatures;
determine the individual's handwritten signature has changed over time;
retrieve a symptom associated with the changed individual's handwritten signature; and
predict an onset of a malady associated with the symptom.
